(19) United States
(12) Patent Application Publication
(10) Pub. No.: US 2014/0157524 A1
(43) Pub. Date: Jun. 12, 2014

(54) PVC Cutting and Gripping Tool

(71) Applicant: Johnny Mote, Magnolia, MS (US)

(72) Inventor: Johnny Mote, Magnolia, MS (US)

(21) Appl. No.: 14/104,742

(22) Filed: Dec. 12, 2013

Related U.S. Application Data
(60) Provisional application No. 61/736,057, filed on Dec. 12, 2012.

(51) Int. Cl. B25F 1/00

(52) U.S. Cl. CPC B25F 1/003
USPC 7/156

(57) ABSTRACT

An improved PVC cutting and gripping tool includes a ratcheting shear blade for cutting pipe. The tool incorporates a set of offset gripping teeth in the handles. The offset gripping teeth are spaced apart to allow a user to securely grip the screw on cap of a metal PVC primer or cement container while the tool's handles are almost fully closed. The ability to grip a container cap with the tool's handles almost completely closed gives the user great leverage to open the container and allows a user with small hands to effectively use the tool. The tool also incorporates a set of inner gripping teeth in the handles that may be used to grip and turn a pipe or other object.

### PRIORITY

This application claims the priority date of U.S. Provisional Application No. 61/736,057, filed Dec. 12, 2012 and incorporated herein by reference.

### FIELD OF THE DISCLOSURE

Plumbing tools and cutting tools.

### BACKGROUND OF THE INVENTION

The present invention relates to an improved PVC cutting and gripping tool for cutting plastic pipe and removing screw-on metal caps from containers. Conventional pipe shears are used for cutting polyvinyl chloride (“PVC”) pipe to different lengths. A user cuts the PVC pipe to the correct length for assembly, the lengths of pipe are prepared for assembly with PVC primer, and then the pipe lengths and fittings are glued together with PVC cement. PVC primer and cement are typically contained in metal containers with screw-on metal caps. The screw-on metal caps may be very difficult to open, forcing a user to carry a separate tool, like a pair of pliers, to open the metal containers. Accordingly, there is a need for a multi-function tool that can be used to cut PVC pipe to length and to open caps for PVC primer and cement containers.

### SUMMARY OF THE INVENTION

The present invention is an improved PVC cutting and gripping tool. The tool has two handles. One handle is fixed and has a fixed jaw. A moveable handle is attached to the fixed handle below the fixed jaw. A moveable shear blade is pivotally attached to the fixed handle opposite the fixed jaw. The shear blade has a series of ratchet teeth incorporated into its rear section. A push pawl is pivotally attached to the moveable handle and has a spring that presses the pawl against the ratchet teeth. When the two handles are squeezed together, the pawl engages the ratchet teeth and forces the shear blade into contact with the fixed jaw.

The present invention also incorporates a set of offset gripping teeth affixed to the two handles. The offset gripping teeth are affixed on the side of the handles in an opposing configuration and are placed on the handles in an area beyond the tool's ratcheting mechanism. The offset gripping teeth are spaced to allow the teeth to grip a PVC primer or cement container cap when the handles are almost fully closed. Spacing the gripping teeth in this manner allows a user with small hands to firmly grip the cap of a PVC primer or cement container. The ability to grip the cap with the handles almost fully closed allows a user to exert great leverage to remove the cap. The invention may also incorporate handles that are longer than a conventional shear, allowing the user to exert even more leverage.

The present invention also incorporates a set of inner gripping teeth in the inner edge of the two handles. The inner gripping teeth are also placed in an area beyond the tool's ratcheting mechanism and do not interfere with the tool's mechanism. The inner gripping teeth allow the user to grip a section of pipe or other object that passes through the two handles.

### BRIEF DESCRIPTION OF THE SEVERAL VIEWS OF THE DRAWINGS

FIG. 1 is a perspective view of the prior art.

FIG. 2 is an objective view of the Improved PVC Cutting and Gripping Tool in the closed position.

FIG. 3 is an objective view of the Improved PVC Cutting and Gripping Tool in the open position.

FIG. 4 is a perspective view of the Improved PVC Cutting and Gripping Tool being used to securely grip the screw-on cap of a PVC cement container.

FIG. 5 is a perspective view of the Improved PVC Cutting and Gripping Tool being used to grip a PVC pipe fitting.

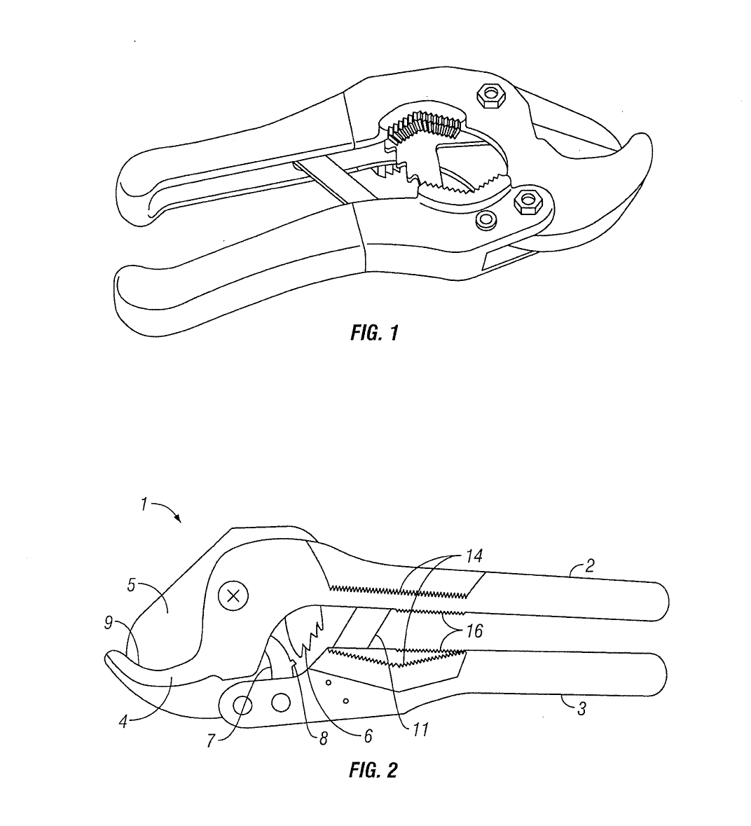

### DETAILED DESCRIPTION

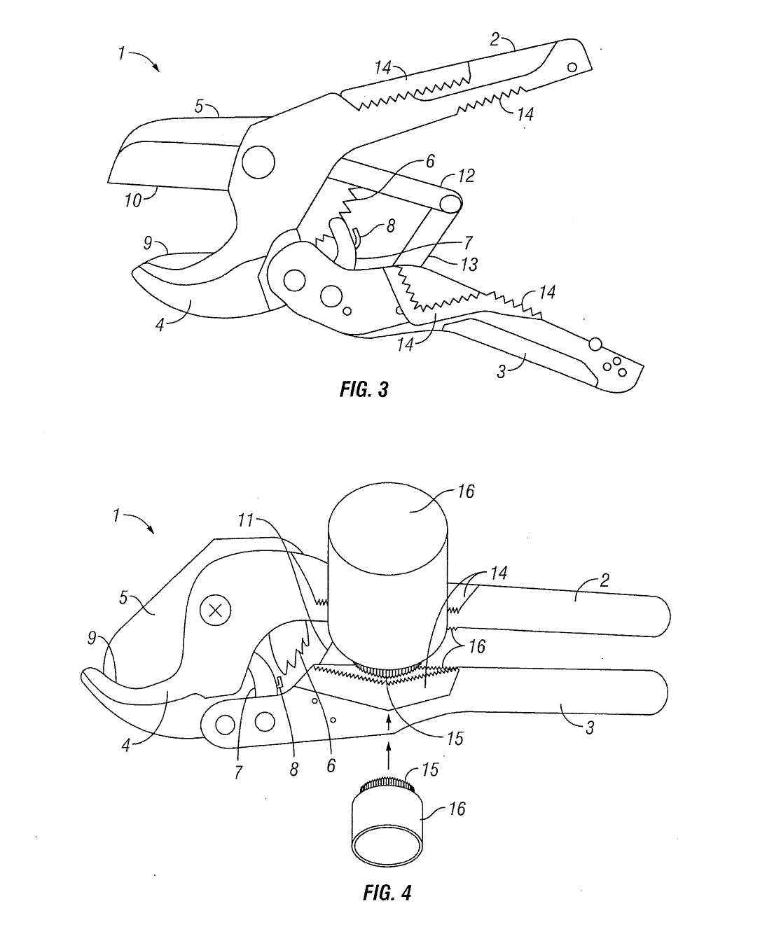

FIG. 2 is an objective view of the Improved PVC Cutting and Gripping Tool 1 in the closed position. The tool 1 is comprised of a fixed handle 2 and a moveable handle 3. The fixed handle 2 includes a fixed jaw 4. The fixed jaw 4 is curved in shape to grip a round PVC pipe. The moveable handle 3 is attached to the fixed handle 2 below the fixed jaw 4. A moveable shear blade 5 is pivotally attached to the fixed handle 2 opposite the fixed jaw 4.

FIG. 3 depicts the tool 1 in the open position. The shear blade 5 has a series of ratchet teeth 6 incorporated into the rear section of the shear blade 5. A push pawl 7 is pivotally attached to the moving handle 3 and has a spring 8 that presses the pawl 7 against the ratchet teeth 6. When the two handles 2, 3 are squeezed together, the pawl 7 engages the ratchet teeth 6 and forces the shear blade 5 into contact with the fixed jaw 4. The fixed jaw 4 incorporates a slot 9 where the sharpened edge 10 of the shear blade 5 rests when the tool 1 is in the closed position.

The tool 1 also includes a connecting rod 11 that includes a first member 12 and a second member 13 that are pivotally connected to each other. One end of the connecting rod 11 is pivotally connected to the moving handle 3, and the other end of the connecting rod 11 is pivotally connected to the rear of the shear blade 6. When the tool handles 2, 3 are moved apart, the connecting rod 11 moves the shear blade 6 and causes the sharpened edge 10 of the shear blade 6 to move away from the fixed jaw 4.

The tool 1 further comprises a set of offset gripping teeth 14 affixed to the two handles 2, 3. The offset gripping teeth 14 are affixed on the side of the handles 2, 3 in an opposing configuration. The offset gripping teeth 14 are placed on the handles 2, 3 in an area beyond the tool's 1 ratchet teeth 7, pawl 8, and connecting rod 11, and the offset gripping teeth 14 do not interfere with the tool's 1 operation. The offset gripping teeth 14 are spaced to allow the offset gripping teeth 14 to grip the cap 15 to a metal container 16 when the handles 2, 3 are almost fully closed. FIG. 4 depicts a cap 15 gripped between the offset gripping teeth 14.

Spacing the offset gripping teeth 14 in this manner allows a user with small hands to firmly grip the cap 15 of a PVC primer or cement container 16. The ability to grip the cap 15 with the handles 2, 3 almost fully closed allows a user to exert great leverage to remove the cap 15. The tool 1 may also incorporate handles 2, 3 that are longer than a conventional shear, allowing the user to exert even more leverage.

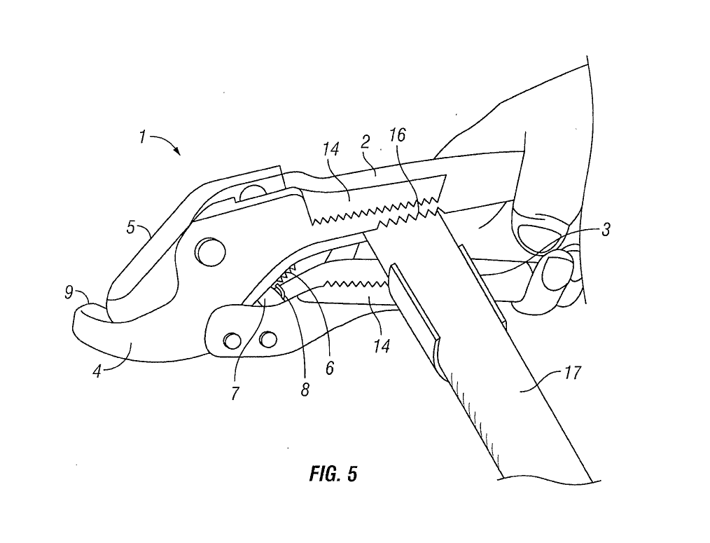

A set of inner gripping teeth 16 are incorporated in the inner edge of the two handles 2, 3. The inner gripping teeth 16 are placed on the handles 2, 3 in an area beyond the tool's 1 ratchet teeth 6, pawl 7, and connecting rod 11, and the inner gripping teeth 16 do not interfere with the tool's 1 operation. The inner gripping teeth 16 allow the user to grip a section of pipe 17 or other object that passes through the two handles 2, 3, as depicted in FIG. 5.

I claim:

1. A cutting and griping tool comprising:
a fixed handle;
a moveable handle pivotally attached to the fixed handle;
a fixed jaw;
a shear blade; and
a set of offset gripping teeth affixed to the two handles.

2. The cutting and gripping tool of claim 1, wherein:
the fixed jaw is incorporated into the fixed handle;
the moveable handle is pivotally attached to the fixed handle below the fixed jaw;
the shear blade is pivotally attached to the fixed handle opposite the fixed jaw;
a series of ratchet teeth are incorporated into the rear section of the shear blade;
a connecting rod with a first member and second member has one end of the connecting rod pivotally connected to the moveable handle and the other end pivotally connected to the rear of the shear blade; and
a push pawl is pivotally attached to the moving handle, and the push pawl engages the ratchet teeth and forces the shear blade into contact with the fixed jaw when the moveable handle and fixed handle are moved together.

3. The cutting and gripping tool of claim 1, wherein the offset gripping teeth are affixed to the two handles in an opposing configuration in an area beyond the ratchet teeth, pawl, and connecting rod.

4. The cutting and gripping tool of claim 1, wherein the offset gripping teeth are spaced to allow the offset gripping teeth to grip the cap of a metal container when the fixed handle and moveable handle are almost fully closed.

5. The cutting and gripping tool of claim 1, wherein the offset gripping teeth comprise a set of plier teeth.

6. The cutting and gripping tool of claim 1, wherein the offset gripping teeth incorporate a flexible material adapted to frictionally engage an object when the offset gripping teeth are drawn together.

7. A cutting and griping tool comprising:
a fixed handle;
a moveable handle pivotally attached to the fixed handle;
a fixed jaw;
a shear blade;
a set of offset gripping teeth affixed to the two handles; and
a set of inner gripping teeth incorporated into the inner edges of the two handles.

8. The cutting and gripping tool of claim 7, wherein:
the fixed jaw is incorporated into the fixed handle;
the moveable handle is pivotally attached to the fixed handle below the fixed jaw;
the shear blade is pivotally attached to the fixed handle opposite the fixed jaw;
a series of ratchet teeth are incorporated into the rear section of the shear blade;
a connecting rod with a first member and second member has one end of the connecting rod pivotally connected to the moveable handle and the other end pivotally connected to the rear of the shear blade; and
a push pawl is pivotally attached to the moving handle, and the push pawl engages the ratchet teeth and forces the shear blade into contact with the fixed jaw when the moveable handle and fixed handle are moved together.

9. The cutting and gripping tool of claim 7, wherein the offset gripping teeth are affixed to the two handles in an opposing configuration in an area beyond the ratchet teeth, pawl, and connecting rod.

10. The cutting and gripping tool of claim 7, wherein the offset gripping teeth are spaced to allow the offset gripping teeth to grip the cap of a metal container when the fixed handle and moveable handle are almost fully closed.

11. The cutting and gripping tool of claim 7, wherein the offset gripping teeth comprise a set of plier teeth.

12. The cutting and gripping tool of claim 7, wherein the offset gripping teeth incorporate a flexible material adapted to frictionally engage an object when the offset gripping teeth are drawn together.

13. The cutting and gripping tool of claim 7, wherein the inner gripping teeth are incorporated into the inner edges of the two handles in an opposing configuration in an area beyond the ratchet teeth, pawl, and connecting rod.

14. The cutting and gripping tool of claim 7, wherein the inner gripping teeth comprise a set of plier teeth.

15. The cutting and gripping tool of claim 7, wherein the inner gripping teeth incorporate a flexible material adapted to frictionally engage an object when the inner gripping teeth are drawn together.
